(19) United States
(12) Patent Application Publication
(10) Pub. No.: US 2025/0371482 A1
(43) Pub. Date: Dec. 4, 2025

(54) SYSTEM AND METHOD FOR IMPROVING HAZARDOUS MATERIALS SHIPMENT LOGISTICS

(71) Applicant: Placardpass, LLC, Nashville, TN (US)

(72) Inventor: Richard Bornhorst, Nashville, TN (US)

(21) Appl. No.: 18/873,536

(22) PCT Filed: Jun. 12, 2023
(86) PCT No.: PCT/US2023/025051

§ 371 Date: Dec. 10, 2024

Related U.S. Application Data
(60) Provisional application No. 63/351,310, filed on Jun. 10, 2022.

(51) Int. Cl. G06Q 10/0832

(52) U.S. Cl. CPC G06Q 10/0832

(57) ABSTRACT

Embodiments of the present invention include systems and methods for reducing physical and logistical transportation bottlenecks in the shipment of hazardous materials. The present invention includes a hub 100 which, in embodiments, is operatively connected to one or more of the following: manual data input means, automatic data input means, image capture device(s), data output devices, traffic signals, entry or exit gates, and one or more regulatory databases.

### CROSS REFERENCE TO RELATED APPLICATIONS

This nonprovisional application claims the benefit of priority under 35 USC § 119 to U.S. Patent Application No. 63/351,310, filed on Jun. 10, 2022, the entirety of which is incorporated herein by reference.

### BACKGROUND OF THE INVENTION

### Field of the Invention

The invention relates primarily to a system and methods for streamlining processes for the shipment of hazardous materials. More specifically, the present invention is a novel software system and method which enables the automation of hazardous materials regulation compliance into transportation management systems, including gate operations and other compliance verification systems and mechanisms.

### Description of the Background

The global transportation supply chain is struggling to replenish inventories and keep up with demand. There is a backlog of containerships outside U.S. ports waiting to off-load containers. Shipments of many essential product components have been severely delayed. One major cause of bottlenecks in transportation logistics can be certification of compliance with regulations regarding the shipment of hazardous materials. There are numerous such overlapping regulations in the United States, and additional, compounding regulations pertaining to shipments which originate or travel abroad.

For example, vehicles that transport hazardous materials inside the United States are required, according to various U.S. regulations, to bear placards that are designed to alert transportation and emergency personnel to the presence of a hazardous material inside the vehicle. The most common instance of a placard appears on a shipping container being transported by a tractor trailer. However, there are more than sixty-six (66) different placards prescribed for use on shipments within the United States, and many more which are prescribed for shipments that cross borders, as required by the laws of foreign countries where such shipments are destined to travel. Each individual placard design displays a unique designation to tell first responders and transportation personnel different, and often overlapping, facts about the hazardous materials contained inside the shipping container or vehicle. Often, a single placard will not suffice to provide the legally required warnings or information about the shipment. For example, one placard may indicate that the hazardous material being shipped is corrosive, still another may indicate that the material is flammable, still another may indicate that the material is explosive, and so on. Compounding the complexity of placard compliance is the fact that a single shipment, on a single truck, may contain numerous hazardous and/or non-hazardous materials, each with different dangerous properties that may require a separate placard. It may also be the case that a single placard, such as one bearing the warning “DANGEROUS” may be legally substituted for some, but not all, other combinations of placards that would otherwise be required for a given shipment.

International shipments of hazardous materials are usually contained in shipping containers which are carried on ships and then lifted onto tractor trailer beds upon arriving at the port, whereby the placard arrangement could remain on the shipping container throughout its journey between countries, and must be compliant with the laws of all countries through which it passes. Thus, considering the laws of the United States and those of each international jurisdiction with which the United States has a trade relationship, there are potentially limitless combinations of mandatory placards, depending on the hazardous material or materials contained in the shipment.

Placard compliance comes into play, and is the cause of transportation and logistical bottlenecks, at multiple points along a shipment's lifespan. On the front end, generation of a compliant placard and/or placard arrangement could be a logistical bottleneck. Front end compliance activities include: (A) determining which regulations (U.S. and/or international) apply to a given shipment; (B) determining which placard or arrangement of placards is compliant with all relevant regulations; (C) determining an optimal arrangement of placards in the case where the shipper only has a portion of the available physical placards on hand, and/or the vehicle or shipping container only has a set number of placard attachment locations; (D) locating the placard(s) in question; and (E) affixing them in a proper location on the vehicle and/or shipping container. During shipment, and upon arriving at a given destination, vehicles or containers may be subjected to numerous compliance checks to ensure that the placard arrangement corresponds to the material(s) being shipped. In many cases, placard compliance must be confirmed before vehicles can access a single entry or exit terminal, such as the secured exit from a seaport. This can be a major physical transportation bottleneck. Thus, depending on the location of the compliance check, such a check can involve: (A) confirming correspondence between the materials in the shipment (as noted on the bill of lading) and the placard(s) on the vehicle or shipping container; (B) manipulating physical barriers to allow compliant shipments to pass through the designed compliance check area; (C) physical correction of non-compliant vehicles and/or shipments; (D) correspondence with the party tendering the shipment, or freight forwarder, and/or (E) maneuvering shipping containers (such as by crane) or vehicles to arrange them in logical configurations for additional compliance checks, correction, unloading, holding, quarantine and/or departure. For vehicles or shipping containers which are not compliant, the result of even one of the above actions could mean that the vehicle/container has lost its spot in “line” to enter or exit the facility, or even missed a ship that was about to set sail, further compounding shipping delays.

In addition to all of the above, the COVID-19 crisis has had an outsized impact on the transportation industry, given that drivers spend most of their time on public roads and often must stop in public places for rest or food.

What is needed, then, is a system and methods which streamline the placard compliance verification process. It would be an added benefit if such system and methods provided means for automatic manipulation of physical barriers, signage, or like physical safety means corresponding to the compliance status of a placard arrangement on a given shipment.

It would be an even greater benefit if such a system and methods could reduce the need for or number of physical touchpoints, both for purposes of transportation worker safety and health, but also as a means to improve efficiency.

### SUMMARY OF THE INVENTION

Embodiments of the present invention include systems and methods for reducing physical and logistical transportation bottlenecks in the shipment of hazardous materials. The present invention includes a hub 100 which, in embodiments, is operatively connected to one or more of the following: manual data input means, automatic data input means, image capture device(s), data output devices, traffic signals, entry or exit gates, and one or more regulatory databases.

The foregoing objects, features and attendant benefits of this invention will, in part, be pointed out with particularity and will become more readily appreciated as the same become better understood by reference to the following detailed description of a preferred embodiment and certain modifications thereof when taken in conjunction with the accompanying drawings. Unlike prior art which attempts to disconnect the human element from technology (presumably due to costs constraints), the present invention provides tangible improvement in the efficiency of shipping operations, including validating compliance with hazardous materials regulations, and in various embodiments, providing more efficient traffic through entry, exit, and compliance checkpoints, and optimizing and automating gating operations related to same.

### BRIEF DESCRIPTION OF THE DRAWINGS

In the drawings:

FIG. 1 is a high-level schematic of the inventive system according to embodiments of the present invention.

FIG. 2 is a flowchart showing the major steps common to both pre-shipment or post-arrival placard compliance checks according to some embodiments of the present invention.

FIG. 3 shows an exemplary GUI generated by the system showing an exemplary processing report that may be output by the system, according to some embodiments of the present invention.

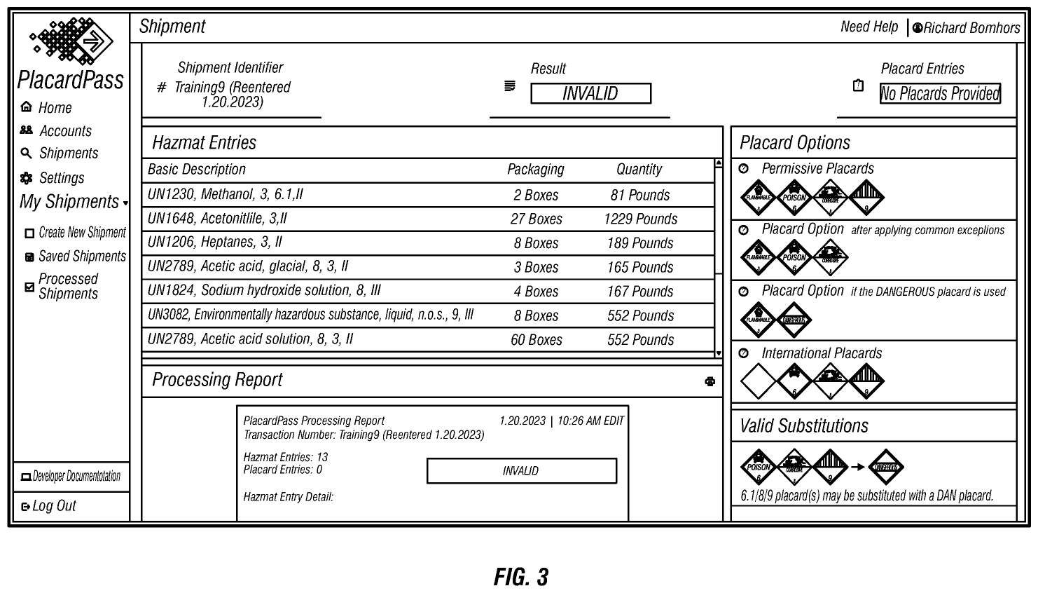

FIG. 4 is a flowchart showing the major steps for the methods of automatically updating shipment records and/or controlling gate operations based on the output from hub 100, according to embodiments of the present invention.

### DETAILED DESCRIPTION OF THE PREFERRED EMBODIMENTS

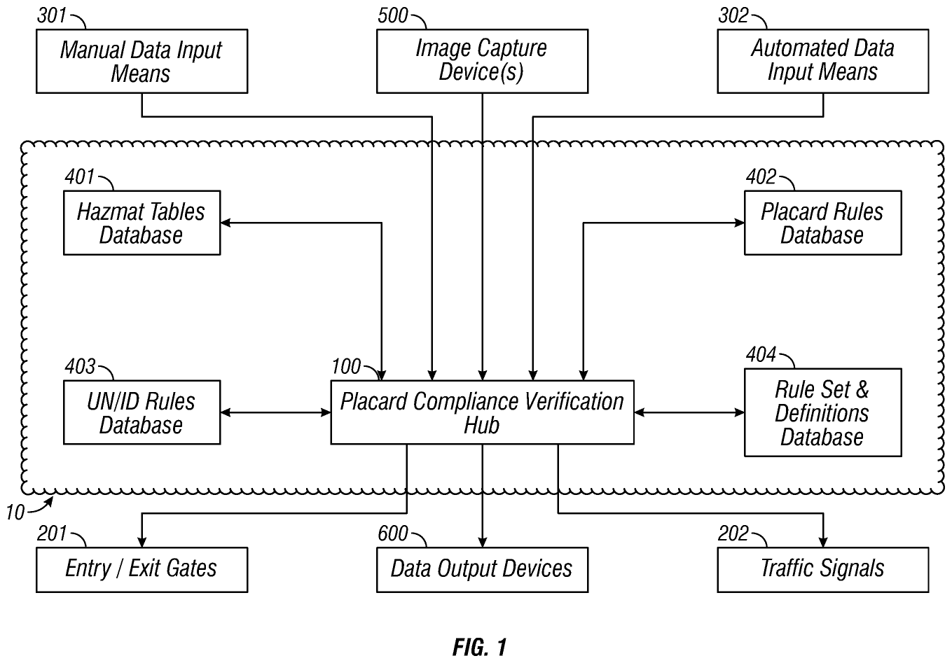

The present invention is a system and methods which reduce regulatory compliance bottlenecks in the transportation of hazardous materials, by, in part, streamlining the hazardous materials placard verification process. Embodiments of the present invention include a software-enabled Placard Compliance Verification Hub (“hub”) 100 which is operatively connected to, and interfaces with, various external components which, in embodiments, collectively enable the accurate operation of one or more physical gating and directing devices 200 and the like in verified compliance with U.S. and international regulations regarding the labeling of hazardous materials shipment containers and vessels. FIG. 1 shows a high-level schematic of the inventive system 10 according to embodiments of the present invention.

In preferred embodiments, hub 100 may include either downloadable or cloud-based processing means capable of running software for performance of various methods as described in more detail herein. In various embodiments, hub 100 interfaces with one or more external data input means 300. In some embodiments, hub 100 includes means for generating one or more graphical user interfaces (GUIs) which can be accessed by a user from one or more manual data input means 301, which could include a desktop computer, mobile phone, tablet, or the like. In such embodiments, hub 100 preferably includes means for generating GUIs that include fillable fields and/or drop-down menus for solicitation of data via manual input by a user. As will be described, solicited data could include: (A) basic description of compound/hazardous material; (B) technical name of compound/hazardous material; (C) number of articles/packages; (D) package type; (E) total quantity, volume, and/or weight; (F) unit of measure; (G) whether or not the compound or hazardous material is a limited quantity; (H) whether or not the compound or hazardous material is an excepted quantity; (I) whether or not the vehicle, vessel or package is empty or uncleaned; (J) whether or not the compound or hazardous material is radioactive; (K) a number of placard securing locations available for the shipment; (L) the type(s) of placard displays available for the shipment; (M) the identity of any physical placards on hand at the shipping location; (N) a name or identifying number for a given shipment; and (O) other identifying information for the given shipment, such as freight company name(s), driver name(s), vehicle type(s), origin, destination, time of departure, time of arrival, and/or route map. In some embodiments, hub 100 includes automated data input means 302, such as operative connections and/or integration into the transportation logistics software system(s) of one or more entities involved in the transportation of hazardous materials, such as freight carriers. In such embodiments, hub 100 includes means for generating queries to one or more third party software system(s) to request data of the type(s) described above with respect to a manual data entry means, and hub 100 further includes means to receive and store such received data in a location available for the data processing software. In some embodiments, hub 100 includes both manual 301 and automated 302 input means.

Also in preferred embodiments, the inventive system includes one or more databases 400 which are operatively connected to hub 100, and further hub 100 includes means for interfacing with (e.g., sending queries to, and receiving data in response to same) said databases 400.

Also in preferred embodiments, the inventive system also includes various image capture devices 500 which are preferably operatively connected to hub 100. Image capture devices 500 may comprise movable or stationary, manual or automatic, cameras at entry or exit points of controlled shipment areas, such as ports and/or regulatory compliance checkpoints along roads, railways, and/or highways or at international border crossings (including road and rail). In embodiments, image capture devices 500 may also comprise cameras on smartphones, user-facing cameras on kiosk-type data entry points, and/or the video feed of security cameras. It will be understood that the present invention is not limited to any specific type of model of image capture device, and it will not depart from the spirit of the invention to adapt the inventive system to include an operative connection with any image capture device now known or developed in the future.

In embodiments, the inventive system also includes various data output devices 600 which are preferably operatively connected to hub 100. Data output devices 600 may include printers, or screens such as the screen on a computer, mobile phone, tablet, kiosk, or the like, which are capable of generating GUIs, based on instructions received from the hub 100, which provide specified information and/or graphical presentations to a user. In preferred embodiments, hub 100 also includes means for display of data via one or more GUIs viewable to a user on a desktop computer, smartphone, tablet or the like, as will be described.

In preferred embodiments of the present invention, databases or tables 400 include, at least, a Hazmat Tables Database 401, a Placard Rules database 402, a UN/ID Rules Database 403, and/or a Rule Set & Definitions Database 404. In embodiments, each such database/table 400 includes a combination of data pertaining to the regulations, rules, opinions from transportation authorities, and/or definitions proscribed by United States, regional, foreign or international law, along with augmentations to tag such data for access by hub 100. In some embodiments, the inventive system also includes means for automatic crawling and scraping of revised, updated and/or new national or international rules or regulations (or opinions) from the public or private databases where such rules/regulations/opinions are published.

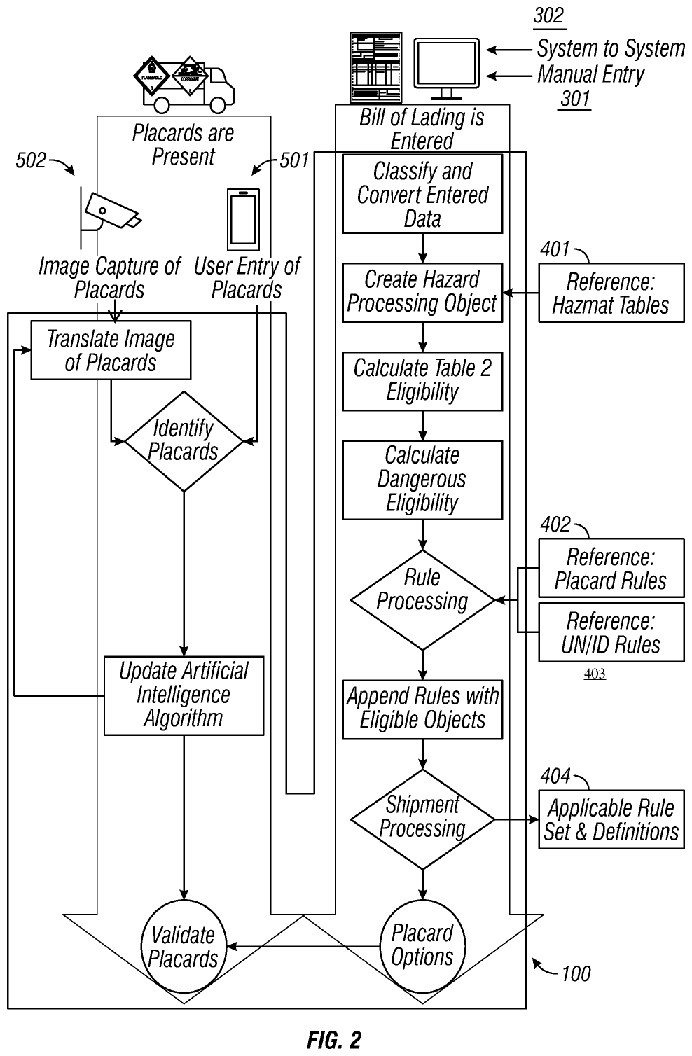

Embodiments of the present invention include methods for pre-shipment or post-arrival placard compliance verification or compliant placard generation. FIG. 2 is a flowchart showing the major steps common to both pre-shipment or post-arrival placard compliance checks according to some embodiments of the present invention.

### Placard Compliance Verification

With reference to FIG. 2, in embodiments of the present invention, hub 100 receives input from one or more image capture devices 500. FIG. 2 illustrates two potential image capture devices, a gate or security-type camera 502, and a camera on a smartphone or tablet 501. A smart device image capture device 501 is one means of manual data entry to hub 100 as described with respect to certain embodiments of the present invention. In some embodiments, the inventive system may alternatively, or additionally, comprise automatic image capture from devices such as a mounted camera 502. In such embodiments, data may be provided to hub 100 either by manual, user-initiated request to camera 502 (i.e., to take a picture and transmit it to hub 100), or hub 100 (i.e., to send a request to camera 502 to take and transmit a picture of a certain vehicle, location and/or at a certain camera angle which may be specified by hub 100 based on optional GPS integrations, as will be described). Alternatively, in such embodiments, data may be automatically provided from camera 502 to hub 100 without user intervention, such as through the use of known motion sensor and image recognition/artificial intelligence technologies to trigger camera 502 to recognize an approaching vehicle or the like, capture an image of the placard arrangement, and transmit it automatically to hub 100 for further processing. Thus, in some embodiments, the inventive system includes motion-sensor enabled cameras 502, and image recognition software which may operate within or remotely from the camera 502 or hub 100. In preferred embodiments, image capture devices 500 provide data in the nature of images of existing placard arrangements on individual vehicles or shipping containers.

In embodiments of the present invention, hub 100 may also receive data regarding the placard arrangement via manual user input via a GUI generated by the system and visible on the screen of a computer, smartphone, tablet, or the like. Such a GUI could further include options from which the user may select one or more placards placed on the vehicle or shipping container in question.

With further reference to FIG. 2, the method steps within the box labeled 100 are conducted by the hub 100. Upon receipt of image data from an automated image capture device 502, it may be necessary for hub 100 to translate the received image data into readable and/or scannable images. Once readable and/or scannable images are obtained, hub 100 identifies the placards, in some cases using artificial intelligence as shown in FIG. 2. In some embodiments, hub 100 sends a query to a Placard Database (not shown) which provides data regarding available placards for comparison by hub 100 against the data retrieved from the image capture device(s) 500. Also as shown in FIG. 2, hub 100 may optionally engage in an artificial intelligence feedback loop to train the inventive system's artificial intelligence mechanism to improve the accuracy of the system's image reading and/or placard identification processes.

In some embodiments, in addition to or as an alternative to means for receipt of image data from image capture devices 500, the inventive system may also include means to receive placard data via electronic interface with or integration into third party transportation logistics software. Thus, in embodiments of the present invention, hub 100 may receive data from such third party systems, which data identifies one or more shipments and the placard arrangement that the shipper has placed on each such shipment. Third party data may be automatically pushed to hub 100 for verification of compliant placard arrangement as described herein, or hub 100 may include programming logic to make periodic queries to such third party software, at specified times and/or on receipt of a manually-entered or automatic notification that a shipment is preparing to leave a departure facility, for example. Regardless of how received, according to embodiments of the present invention, hub 100 will identify the placards proposed for placement on each individual shipment of hazardous material and proceed to validate the placard arrangement, as will be described.

As shown along the right side of FIG. 2, in embodiments of the present invention involving methods of pre-shipment or post-arrival placard compliance verification or compliant placard generation, hub 100 also receives shipment data from manual data input means 301 and/or automated data input means 302. Both means of shipment data entry are shown with reference to FIG. 2. The system may generate a GUI for solicitation of shipment data from a user via a computer, smartphone, tablet or the like. Thus, GUI may request data including: (A) basic description of compound/hazardous material; (B) technical name of compound/hazardous material; (C) number of articles/packages; (D) package type; (E) total quantity, volume, and/or weight; (F) unit of measure; (G) whether or not the compound or hazardous material is a limited quantity; (H) whether or not the compound or hazardous material is an excepted quantity; (I) whether or not the vehicle, vessel or package is empty or uncleaned; (J) whether or not the compound or hazardous material is radioactive; (N) a name or identifying number for a given shipment; and/or (O) other identifying information for the given shipment, such as freight company name(s), driver name(s), vehicle type(s), origin, destination, time of departure, time of arrival, and/or route map. Hub 100 also includes means to logically associate more than one type of hazardous material, package type, and like information with a given shipment, and either obtain or generate a unique identifier for such shipment. In preferred embodiments, hub 100 stores shipment data (as well as the associated or recommended placards and compliance check results, as will be described) along with a unique shipment identifier in a searchable database that can be queried by a user or third-party shipping software. The system may generate a GUI allowing such stored data to be stored and/or searched by a user. The system may also generate a GUI presenting, by hub 100, compiled data from the results of multiple compliance checks and/or placard generation operations to the user, whereby data entered by individual users or entities can be logically associated with one or more accounts (and login credentials for same) held by such individual or entity for security.

In some embodiments, hub 100 may receive shipment data automatically, such as by integration with third party shipment logistics software as described above with reference to receipt, by hub 100, of placard arrangement data. Other means for receipt of shipment data include operative connection between hub 100 and a scanner or the like device, which can provide a readable-text version of a bill of lading or like document pertaining to a given shipment.

Referring again to FIG. 2, upon receipt of shipment data via automatic or manual entry, hub 100 preferably performs the following steps, including sending queries to, and receiving data from, one or more databases 400 maintained in connection with the system: hub (1) classifies and converts entered shipment data; (2) creates a hazard processing object (with reference to Hazmat Tables Database 401); (3) calculates table 2 eligibility; (4) calculates dangerous eligibility; (5) completes a rule processing operation (with reference to Placard Rules Database 402 and UN/ID Rules Database 403); (6) appends rules with eligible objects; (7) completes a shipment processing operation (with reference to Applicable Rule Sets & Definitions Database 404); and (8) generates one or more compliant placard arrangement options.

As described above, the automatic generation of one or more compliant placard arrangements, in and of itself, represents a marked improvement over current methods for placard arrangement generation, which could include manual reference and cross-checking of the myriad regulations applicable to U.S. and cross-border shipments, and consideration of potentially limitless placard configurations. The inventive system can also account for placards on hand and number and type of placard attachment locations to optimize the arrangement of placards on a shipment; another concrete improvement over prior, manual means for placard generation.

As noted above, one type of data input to hub 100 could be data regarding a proposed route on which a given shipment will travel. Therefore, in embodiments, the inventive method may also include analyzing such route data to identify each individual jurisdiction, inclusive of the United States and foreign countries, in which a given shipment may travel. Based on this analysis, hub 100 can send queries to the appropriate databases 401, 402, 403, 404 to verify that placards or recommended placard arrangements are compliant with the regulations in all relevant territories.

In some embodiments, methods of the present invention include placard compliance verification. In such embodiments, hub 100 then compares the one or more compliant placard arrangement options against the placard arrangement associated with the shipment, via the placard data collected by hub 100 as described above. Hub 100 may then generate an output which, in some embodiments, includes either a pass indicator or a fail indicator, indicating that the placards selected for placement on the shipment are either compliant or not compliant, respectively. In some embodiments, output generated by hub 100 may also include recommendations, such as a recommendation to add, subtract, or substitute a selected placard to gain compliance.

In embodiments, hub 100 shows one or more of the output types described above via a GUI to a user, such as a shipment manager. The system may generate a GUI whereby the user can identify information for various shipments which have been processed according to the method(s) described herein, and green/red (or pass/fail) indicators can signify whether the placards selected for placement on the shipment are compliant.

In some embodiments, hub 100 generates one or more signals and/or data transmissions corresponding to the output produced by the disclosed method(s). In some embodiments, hub 100 may send a signal to a computer, tablet, smartphone, kiosk, or the like that includes: (1) identifying information for a given shipment; and (2) pass/fail indication regarding compliance of the placards on such shipment. In this way, the operator of an entry/exit gate, checkpoint, or the like can enter identifying data for a given shipment when the vehicle or shipping container approaches the gate/checkpoint, and receive an immediate indication of whether or not the shipment's placards are compliant. In embodiments, data for a given shipment can be logically associated by hub 100 with route data received by hub 100 pertaining to that shipment, and hub 100 can generate an automatic data “push” to each gate and/or checkpoint along a given route including shipment identifying data and placard compliance data. In this way alone, the inventive system will reduce backlog and bottleneck caused by current means of placard verification at those various gates or checkpoints.

In some embodiments, hub 100 generates a command signal corresponding to the output produced by the disclosed method(s), which command signal is executable by one or more gating and/or directing devices 200 along the anticipated route of travel for the given shipment, as will be described herein.

In some embodiments, hub 100 generates a signal corresponding to the output produced by the disclosed method(s) which is transmitted back to third party logistics software used by the owner of a given shipment. In this way, the inventive system provides a means for a shipping company to confirm compliance of one or more shipments in advance, and store such data for further use or reference as described herein.

### Compliant Placard Generation

In some embodiments, methods of the present invention include generation of one or more compliant placard arrangements based on the specific contents of a given shipment.

Thus, in some embodiments, the method for generation of compliant placard arrangement(s) proceeds as described above with respect to receipt, by the hub 100, of shipment data via manual data input means 301 or automated data input means 302; or via integration with third party shipment software. With reference to the right side of FIG. 2, hub performs the following method steps: (1) classifies and converts entered shipment data; (2) creates a hazard processing object (with reference to Hazmat Tables Database 401); (3) calculates table 2 eligibility; (4) calculates dangerous eligibility; (5) completes a rule processing operation (with reference to Placard Rules Database 402 and UN/ID Rules Database 403); (6) appends rules with eligible objects; (7) completes a shipment processing operation (with reference to Applicable Rule Sets & Definitions Database 404); and (8) generates one or more compliant placard arrangement options.

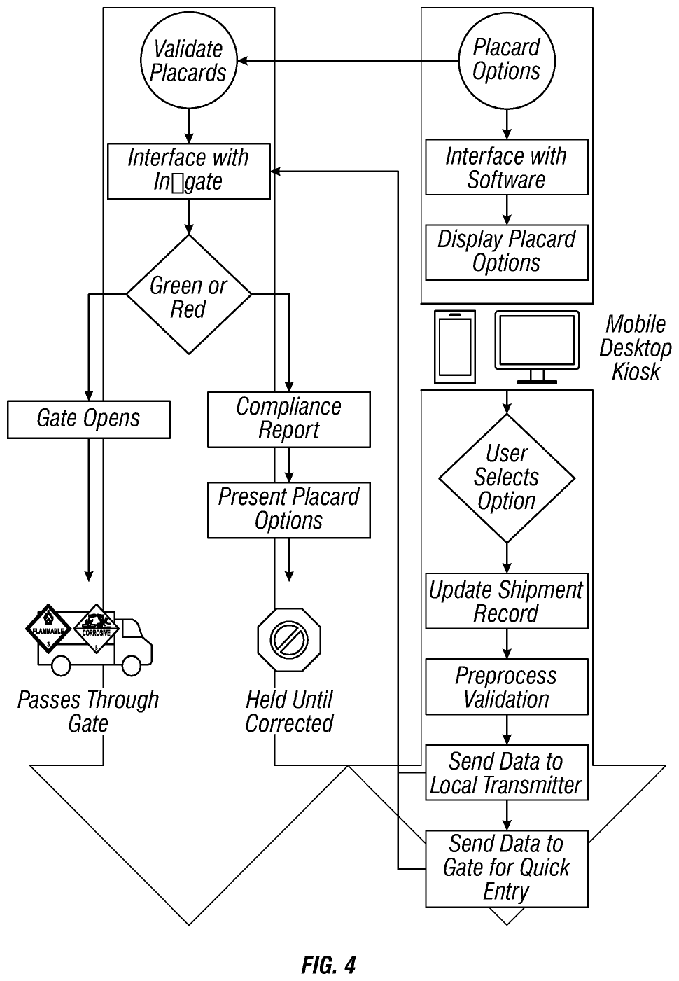

With reference now to FIG. 4, output from hub 100 includes one or more compliant placard arrangement options. Thus, in embodiments, output from hub 100 may include a visual representation of the one or more sets of compliant placard arrangements, via GUI to a user. In some embodiments, additional inputs to the system may include (M) the identity of any physical placards on hand at the shipping location. Thus, hub 100 may incorporate this data into the steps of shipment processing and/or generating one or more compliant placard arrangement options, such that the only options presented to the user are those which correspond with the number of placard placement locations on the vehicle/container and the physical placards available for use at the shipping location.

In some embodiments, output from hub 100 may also include command signal(s) to one or more data output devices 600. In embodiments, a data output device 600 comprising a printer is operatively connected to hub 100 such that hub 100 can generate a command signal for the printer to produce printed output including the one or more sets of compliant placard arrangements. In some embodiments, the inventive methods also include queries to various databases 401, 402, 403, 404 to retrieve the then-operative rules and regulations proscribing placard placement on hazardous materials shipments, and sending command signals to a printer 600 to print such materials for use as reference materials, or for support for the placard arrangement on the shipment, by the shipping company or driver. In embodiments, the inventive method also includes receiving, by hub 100, data regarding the route of a shipment in question, and identification, by the hub 100, of all jurisdictions through which such shipment will pass. Thus, output signals from hub 100 can include command signals for printing all relevant rules and regulations pertaining to all jurisdictions through which the shipment will pass.

In embodiments, one or more data output device(s) may also comprise electronic, and wirelessly connected, placard signage physically located on the container or vehicle in which a given shipment will be transported. In such embodiments, inputs to hub 100 may also include (K) a number of placard securing locations available for the shipment; and/or (L) the type(s) of placard displays available for the shipment. Following the methods described herein, then, hub 100 may also generate one or more command signals to said one or more electronic placard signs which cause said signs to automatically generate visual representations of a compliant placard set. According to such embodiments, a sub-step may include visual presentation of various compliant placard options to a user, and user selection of one of the options, before transmission of the control signal(s) to the electronic placard signage. Also in embodiments, the method may include soliciting data regarding the identify of any pre-existing placards on the container or vehicle, as described above, and making recommendations, or sending command signals, related only to new or substitute placards which are required for compliance. In some embodiments, the method may proceed without user intervention whereby the hub 100 automatically chooses the optimal placard arrangement based on number of placard locations, existing placard signage, and type of placard. Hub 100 may then present only a single, optimal arrangement to the user, or in the case of electronic placard signage, automatically send control signal(s) to effectuate the display of the optimal placard arrangement.

Electronic placard signage may be of any type known in the art, including that described in U.S. Patent Application Publication No. 2017/0193883. In some embodiments, electronic placards may include magnets or other means to automatically flip between tangible placards, versus electronic representations of same.

As described above, once a compliant placard arrangement has been generated on the respective vehicle or shipping container, hub 100 may send one or more signals to gates, traffic signaling devices, checkpoint computers or operators, or the like to allow the shipment to pass through as a verified, compliant shipment without additional checking. Alternatively, where hub 100 makes suggestions regarding one or more compliant placard arrangements, the method can proceed to include visual check, as described above, to confirm that a compliant placard arrangement has indeed been affixed to the vehicle or container.

With reference to FIG. 4 (right side), embodiments of the present invention include methods for automatically updating shipment records for shipments of hazardous materials based on the output from hub 100 following one or more of the methods described above. As shown in FIG. 4, upon selection, by the user or the system, of a compliant placard arrangement, hub 100 may update a user-(or third party software)-provided shipment record, or generate a new shipment record using placard and shipment received as data inputs to the system. Additionally, the method may comprise the steps of: (1) preprocessing validation; (2) sending data to local transmitter; and (3) sending data to gate for quick entry (as described elsewhere herein).

### Automated Gating and Traffic Signaling

As described above, methods of the present invention may include generation, by hub 100, of control signals to one or more entry or exit gates 201, traffic signals 202, or similar physical traffic control devices, based on output from the system, including pass/fail indicators to identify whether a specific shipment is compliant with all relevant regulations for placard placement.

Thus, in some embodiments, the inventive system includes physical gating mechanisms which are operated by one or more electronic motors, such motors being connected via wireless or wired means to hub 100 for receipt of control signals therefrom. Thus, in some embodiments, upon approaching an entry/exit gate equipped with such an operatively connected gating mechanism, an operator or driver can enter identifying information for a given vehicle or shipment to a computer, tablet, or smartphone device which is in communication with hub 100.

In response to a query received from such a device, hub 100 can provide a control signal to the electronic gating mechanism to open or otherwise provide a visual signal of compliance, without the need for further compliance verification by the gate operator or driver. It can be seen that, in this way, the need for a human gate operator can be eliminated, and a driver can provide shipment identifying information to a kiosk or on-site computer, which causes the electronic gate to open automatically in the case of placard compliance corresponding to the given vehicle or container.

In some embodiments, physical barriers can be replaced with traffic lights (green or red) to perform the same functionality as that described immediately above.

In some embodiments, automatic operation of physical gating and/or traffic signals can be aided by a mounted camera or like device which scans for identifying information visible on the exterior of a vehicle or shipping container, and sends data pulled from such identifying information (such as a QR code) to hub 100. Hub 100 may then query its database of stored shipment data to find the corresponding shipment, and if present, send a control signal to the gate and/or traffic lights corresponding to the compliance status of the respective shipment.

In addition, embodiments of the present invention can include GPS tracking mechanisms operatively connected to hub 100 and physically present on the vehicle(s) or shipping container(s) whose shippers utilize the inventive system described herein. Thus, in addition to or as an alternative to visual recognition of a shipment approaching a gate, the shipment's location can be identified by GPS tracker, and control signals (or other data, in the case of human operated checkpoints) can be sent to the gates or checkpoints through which the shipment is passing, to provide visual indication of compliance verification and/or automatic gate operation to allow the vehicle to pass without any interaction with gate hardware, on-side computers, cameras, or human attendants.

The major steps of the above-described method are represented on the left side of FIG. 4. Also as shown in FIG. 4, gate or traffic signal devices may assist with directing traffic for non-compliant vehicles, such as by using overhead or path lighting to direct compliant vehicles to an exit gate or non-compliant vehicles to a holding area.

Likewise, in embodiments, the integration of hub 100 with GPS devices can provide major improvements to the efficiency of port operations by reducing bottlenecks caused by compliance verification at entry and exit gates. In exemplary embodiments, multiple vehicles equipped with connected GPS devices can be monitored by the inventive system in connection with each individual vehicle's status as “placard compliant”, as verified by the inventive system as described herein. Hub 100 may then interface with traffic signals or other traffic directing mechanisms to guide vehicles into various physical locations. For example, the inventive system may direct all compliant vehicles to line up in a specified area where an automated gate will allow them to pass through rapidly without further compliance checks. Vehicles which have been determined to be not in compliance can be directed to a separate area where they can be manually checked, or receive updated placards, without interfering with the efficient passage of verified compliant vehicles. Separately, vehicles which have not yet been checked for placard compliance could be directed to an area where manual, or automated (via camera, as described herein) compliance checks could take place, with additional overhead or path lighting then directing them to a holding area for non-compliance, or to an automatic, quick exit gate following compliance verification.

As can be seen, the disclosed system and methods provide major improvements for management of the logistics of hazardous material transport, by alleviating bottlenecks at the front end of a shipment's lifespan, by (a) eliminating the need to determine which regulations (U.S. and/or international) apply to a given shipment; (b) eliminating the need to determine which placard or arrangement of placards is compliant with all relevant regulations; (c) eliminating the need to determine an optimal arrangement of placards in the case where the shipper only has a portion of the available physical placards on hand, and/or the vehicle or shipping container only has a set number of placard attachment locations; and in some embodiments, (d) eliminating the need to locate the placard(s) in question and/or affix them in a proper location on the vehicle and/or shipping container. The inventive system and methods will also alleviate physical and logistical bottlenecks at entry/exit gates and compliance checkpoints for hazardous materials, by: (a) automatically confirming correspondence between the materials in the shipment (as noted on the bill of lading) and the placard(s) on the vehicle or shipping container; (b) enabling automatic manipulation physical barriers to allow compliant shipments to pass through the designed compliance check area; and/or (c) enabling automatic traffic control mechanisms to maneuver shipping containers (such as by crane) or vehicles to arrange them in logical configurations for additional compliance checks, unloading or quarantine (in the case of failed compliance checks) or departure.

### STATEMENT OF INDUSTRIAL APPLICABILITY

The global transportation supply chain is struggling to replenish inventories and keep up with demand. There is a backlog of containerships outside U.S. ports waiting to off-load containers. Shipments of many essential product components have been severely delayed. One major cause of bottlenecks in transportation logistics can be certification of compliance with regulations regarding the shipment of hazardous materials. There are numerous such overlapping regulations in the United States, and additional, compounding regulations pertaining to shipments which originate or travel abroad. The present invention provides a means to streamline these operations, and remove bottlenecks, via a system that can improve the timing and accuracy of the compliance verification process.

We claim:

1. A system for reducing physical and logistical transportation bottlenecks in the shipment of hazardous materials, the system comprising:
a placard compliance verification hub;
at least one regulatory database operatively connected to said placard compliance verification hub;
at least one input means operatively connected to said placard compliance verification hub;
at least one image capture device operatively connected to said placard compliance verification hub; and
at least one data output device operatively connected to said placard compliance verification hub.

2. The system of claim 1, further including at least one automated electronic entry or exit gate operatively connected to said placard compliance verification hub.

3. A method for reducing physical and logistical transportation bottlenecks in the shipment of hazardous materials, the method comprising:
receiving a first set of data including shipping details for a shipment of hazards materials;
receiving a second set of data including identification of one or more hazardous material placards corresponding to said shipment, said one or more hazardous material placards collectively comprising a placard arrangement;
determining a compliance status of said placard arrangement with regulations related to said shipment; and
sending a pass/fail signal related to said compliance status to an output device.

4. A method for reducing physical and logistical transportation bottlenecks in the shipment of hazardous materials, the method comprising:
receiving a first set of data including shipping details for a shipment of hazards materials;
generating a second data set including identification of one or more hazardous material placards required for compliance of said shipment with one or more hazardous materials regulations, said one or more hazardous material placards collectively comprising a placard arrangement.

5. The method of claim 4, further comprising:
sending a control signal related to said placard arrangement to an output device.
